(19) United States
(12) Patent Application Publication
(10) Pub. No.: US 2009/0043778 A1
(43) Pub. Date: Feb. 12, 2009

(54) GENERATING ETL PACKAGES FROM TEMPLATE

(75) Inventors: Mahesh Jambunathan, Bothell, WA (US); Mukeshkumar M. Beher, Redmond, WA (US); Santosh Tawde, Bellevue, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/835,629

(22) Filed: Aug. 8, 2007

(51) Int. Cl. G06F 17/30

(52) U.S. Cl. 707/10; 707/E17.009

(57) ABSTRACT

Packages for server data extraction, transformation and loading (ETL) are generated and managed through package templates. The templates include configurable and static parameters and are created from user input. Package instances having template property values are created from the templates and then transformed into a package used to implement ETL functionality. In some embodiments, a package template may include one or more components for retrieving data from a source, transformation of the retrieved data before it is stored, and storage of the data at a destination. Packages can be modified based by importing the package, changing an instance associated with the modified package, and generating a package from the modified instance.

### BACKGROUND

As applications provided over the Internet have developed, so has the need for efficient data processing. Many data stores use extract, transform and load (ETL) functionality with servers such as SQL servers to process and manage data. ETL functionality may be implemented by sets of code called “packages” which retrieve source data from a source, process the data, and store the data to as destination data at a chosen destination.

When the format of source data or destination data changes, the packages must be changed as well. For example, source data may have a column that is split into multiple columns, a column name may change, or the destination data may change, for example, a column or server may be renamed or moved to a different location. When source data or destination data formats change, the packages must be changed as well. Typically, packages are changed manually. This requires a large amount of user bandwidth and subjects the resulting package changes to a higher possibility of error.

### SUMMARY

The present technology, roughly described, creates and manages packages that provide extraction, transformation and loading (ETL) functionality. The packages are ultimately generated from templates that include configurable and static parameters. The templates are created from user input or stored data, and package instances having values for the template properties are created from the templates. The instances are then transformed into a package used to implement ETL functionality.

In some embodiments, a package template may include one or more components for retrieving data from a source, transformation of the retrieved data before it is stored, and storage of the data at a destination. The template may specify one or more static or configurable properties for each package component. Configurable properties are configured with values in each instance created from a template.

Once an instance is created, the instance may be translated into a package. In some embodiments, generating a package from an instance includes generating a parameter file from the instance using the parameter file to translate the template into a package. In addition to generating new packages, the present system may be used to modify existing packages.

One embodiment ultimately generates a package from a template. A template is generated for package which is to be used with a destination, such as but not limited to an SQL server. The template has a source component, data transformation component and a destination component. At least one of the components includes one or more configurable properties which are designated as configurable by a user. Next, an instance is generated from the template and includes values for the one or more configurable properties. A package is then generated from the instance. The package is configured to retrieve data from one or more sources identified by the source component, store the data in one or more destinations identified by the destination component, and includes a mapping between the one or more sources and the one or more destinations.

One embodiment creates a package and is able to modify the package. A first package is created from a template instance. The template instance contains a source component configured to retrieve source data, a data transformation component configured to process the retrieved data, and a destination component configured to store destination data at an SQL server. The first package also includes at least one source component property, destination component property, and a mapping associated with the source data and destination data. An instance associated with the first package is accessed and one or more component properties of the accessed instance are changed. A modified package is then generated based on the changed instance.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example of a data flow during creation of a package.

FIG. 2 is an embodiment of a system for generating packages from a template.

FIG. 3A is a logical block diagram of an embodiment of a packaged template application.

FIG. 3B is a logical block diagram of an embodiment of a package.

FIG. 4 is an example of a package template schema.

FIG. 5 is an example of a template instance schema.

FIG. 6 is an example of a package schema.

FIG. 7 is a flow chart of an embodiment of a method for creating a package.

FIG. 8 is a flow chart of an embodiment of a method for creating a package template.

FIG. 9A is a flow chart of an embodiment of a method for adding a source component and component properties to a template file.

FIG. 9B is a flow chart of an embodiment of a method for adding a data transformation component and component properties to a template file.

FIG. 9C is a flow charter of an embodiment of a method for adding destination component and component properties and mappings to a template.

FIG. 10 is a flow chart of an embodiment of a method for creating a template instance.

FIG. 11 is a flow chart of an embodiment of a method for creating a package.

FIG. 12 is a flow chart of an embodiment of a method for updating a package.

FIG. 13 is an example of an initial interface provided by a package template application.

FIG. 14 is an example of an interface for creating a template.

FIG. 15 is an example of an interface used to create a template instance.

FIG. 16 is an example of an interface for generating a package.

FIG. 17 is a block diagram of an embodiment of a competing environment for implementing the present technology.

### DETAILED DESCRIPTION

The present system creates and manages packages that provide ETL functionality. The packages are ultimately generated from templates. The templates may include configurable and static parameters and are created from user input or stored data. Package instances having values for the template properties are then created from the templates. The instances are then transformed into a package used to implement ETL functionality.

In some embodiments, a template (and eventually the resulting package) includes a source component, data transformation component and destination component. A source component handles retrieving data from a source. A data transformation component handles any transformation of the retrieved data before it is stored. A destination component handles storage of retrieved and optionally processed data at a destination.

The template may specify one or more properties for each package component. The properties may be static or configurable, as indicated by a user creating or modifying the package through the present system. An instance is created from the template and may contain different values for the template properties. Thus, configurable properties are configured with values in each instance created from a template. Different instances may contain different values for a configurable property. Some components may also include mappings. For example, a destination component may include a mapping which indicates which source column data is to be placed in a particular destination column. Thus, if the name or other information between source column data and destination column data is different, configurable mapping components are used to decide the mapping.

Once an instance is created, the instance may be translated into a package. In some embodiments, generating a package from an instance includes generating a parameter file from the instance. The parameter file indicates the differences between the instance and the template and is used to translate the template into a package. The generated template includes identification information for the instance and template from which it was ultimately generated from.

In addition to generating new packages, the present system may be used to modify existing packages. Packages can be modified simply by importing an existing package into the system and translating the package into an instance. Accordingly, when a package is imported, it is associated with a template. The instance can then be modified by the user, such as the values for one or more configurable component properties. A modified package can then be generated from the modified instance.

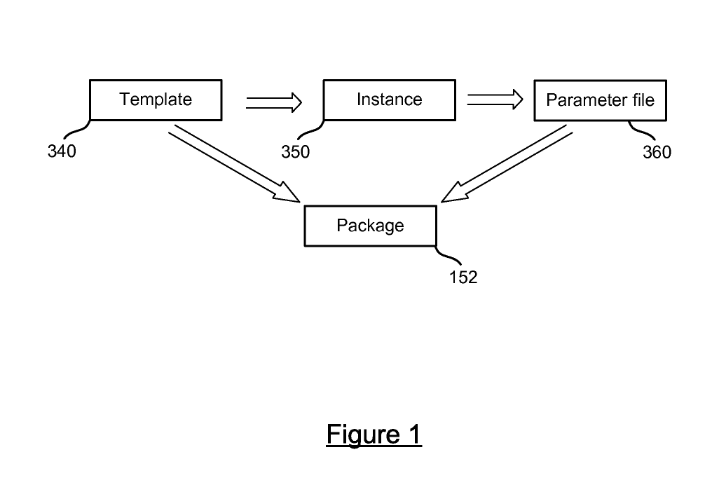

FIG. 1 illustrates an example of data flow during creation of a package. As indicated, first a template 340 is generated. The template 340 consists of a package body with a source component, data transformation component and destination component, each with properties, and optionally, mappings. An instance 350 is then created from the template 340. The instance 350 may provide further details for template 340 by including values for any configurable components, properties and mappings for the template 340. When a package 152 is to be generated from instance 350, a parameter file 360 is generated from the instance. Parameter File 360 may contain changes in the instance 350 with respect to template 340. In some embodiments, parameter file 360 may be in .xml format and contain properties and component-named data. After parameter file 360 is generated, Package 152 is generated from the file and template 340. In particular, parameter file 360 is used to translate template 340 into package 152.

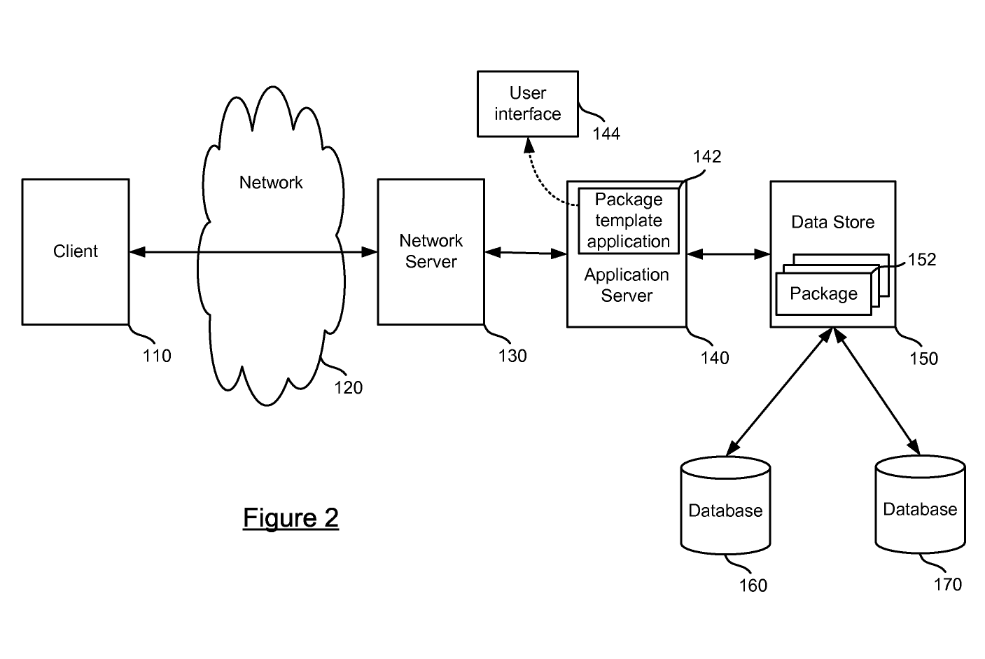

FIG. 2 is an embodiment of a system for generating packages from a template. The system of FIG. 2 includes Client 110, Network 120, Network Server 130, Application Server 140, Data Store 150 and Data Bases 160 and 170.

Client 110 may be implemented as a machine, mobile device or some other device which may communicate with Network Server 130 over Network 120. In some embodiments, a user of client 110 may run an application on client 110 to access Network Server 130 or Application Server 140. Network 120 may be implemented as any public network, private network, a WAN, LAN, intranet, extranet, or other network or networks. In some embodiments, Network 120 may be implemented as the Internet.

Network Server 130 provides a service over Network 120 and may communicate with Client 110 and Application Server 140. In some embodiments, Network Server 130 may provide content as part of a network service to Client 110 in response to requests received from Client 110 over Network 120. When Network 120 is implemented as the Internet, Network Server 130 may be implemented as a Web server and provide a Web service over Network 120.

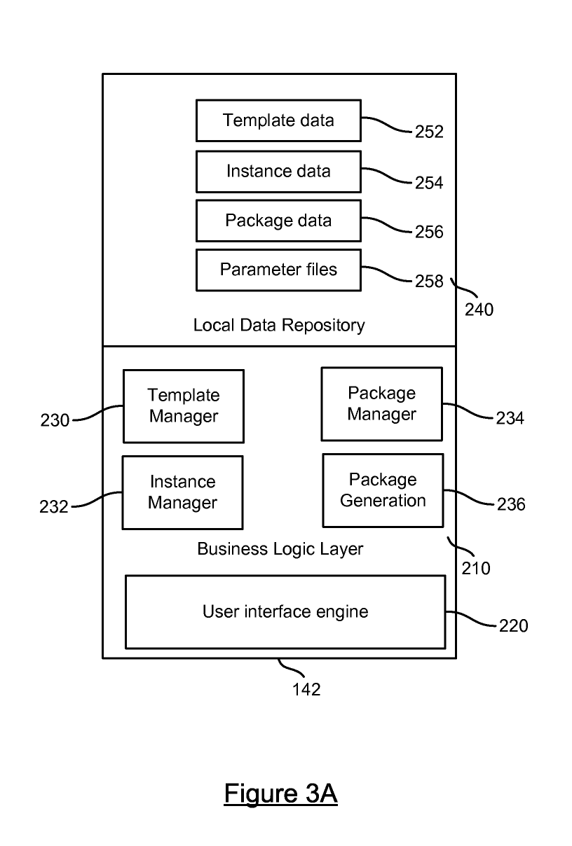

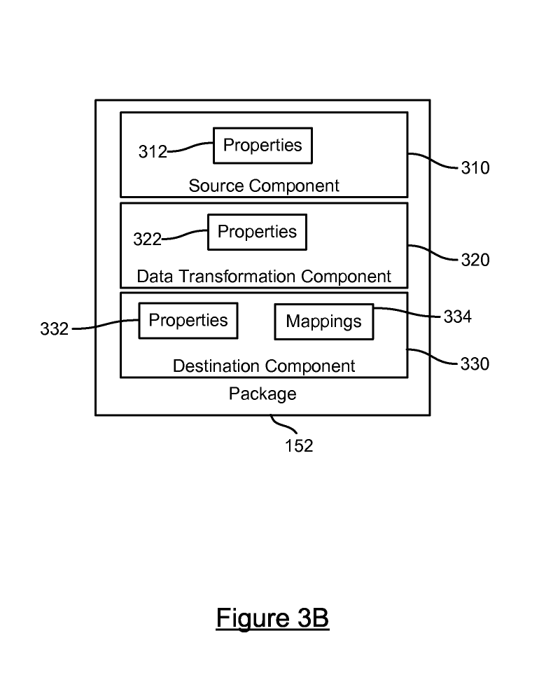

Application Server 140 includes Package Template Application 142 and is in communication with Network Server 130 and Data Store 150. Application Service 140 may process requests received from Network Server 130 and make requests to Data Store 150. Package Template Application 142 may create, modify and manage templates, instances, and packages. Package Template Application 142 may also be stored on Data Store 150 or some other location. In some embodiments, a user of Package Template Application 142 may ultimately create and manage packages from a template. Generally speaking, references to a user herein are intended to reference a user of package template application 142. In some embodiments, package template application 142 is implemented as “SQL Server Integration Service” (SSIS) by Microsoft Corporation, of Redmond, Wash. Package Template Application 142 is discussed in more detail below with respect to FIG. 3A.

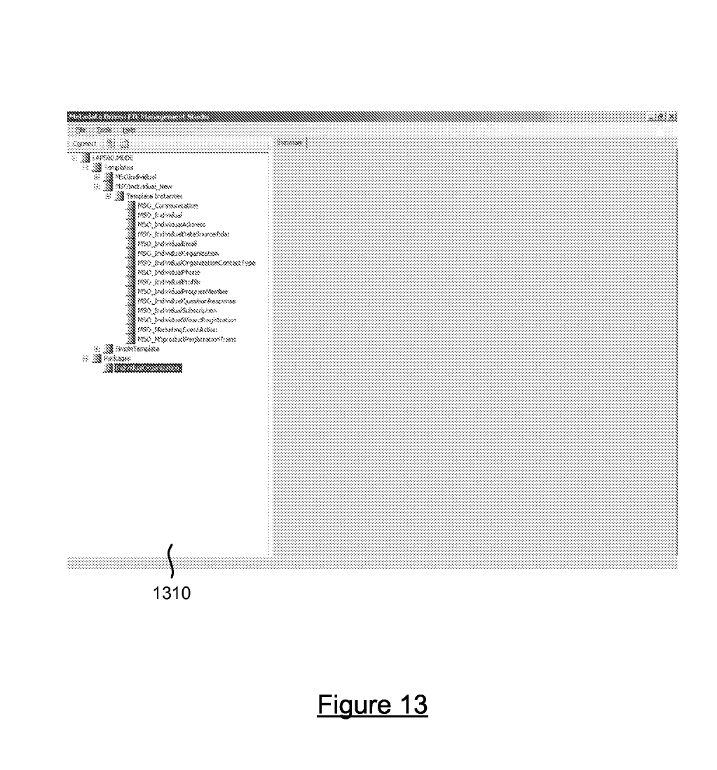

User Interface 144 is provided by Package Template Application 142 and may be used as a tool to implement the functionality of Application 142, in particular to create and manage package templates, instances and packages. Examples of User Interface 144 are discussed in more detail below with respect to FIGS. 13-16.

Data Store 150 includes one or more packages 150 and is in communication with Application Server 140 and Data Bases 160-170. Data Store 150 may include data, an interface, a business logic layer, and other modules. In some embodiments, Data Store 150 may be implemented as an SQL server.

Data Bases 160-170 may be used to store data which may be retrieved or provided by Package 152. For example, Package 152 may retrieve data from Data Base 160 and store data in Data Base 170. Thus, Data Bases 160-170 may serve as data sources or data destinations for data handled by Package 152. Other sources or destinations of data processed by Package 152 may include a file, documents, or some other data at some other location.

FIG. 3A is a logical block diagram of an embodiment of Package Template Application 142. Package Template Application 142 of FIG. 3A includes Local Data Repository 240 and Business Logic Layer 210. Business Logic Layer 210 includes Template Manager 230, Instance Manager 232, Package Manager 234, Package Generation 236 and User Interface Engine 220. Local Data Repository 240 includes Template Data 252, Instance Data 254, Package Data 256, and Parameter Files 258.

Template Manager 230 may be used to create and delete templates from Data Repository 240 or any other location in which templates are stored. The template manager provides template components and component properties to requesting entities. The template data created or deleted may be part of Template Data 252. Instance Manager 232 may be used to create, update and delete template instance data such as Instance Data 254. Instance Manager 232 may create instances from templates described within Template Data 252.

Package Manager 234 may update, delete, import or export package data such as Package Data 256 from Repository 240. Package Generation 236 may generate packages by applying changes indicated in parameter files to a template. Thus, Package Generation 236 generates Package Data 256 based on Parameter Files 258 and Template Data 252. User Interface Engine 220 provides Interface 144 to leverage the functionality provided by Package Template Application 142. The interface engine is used to aid in the managing of templates, instances and packages by the application.

Template Data 252 is data which describes one or more templates. The data includes a skeleton framework for the general format and interface of a package. In one embodiment, a template may be generated for a particular format of package desired, have components which may or may not be marked as configurable, and have one or more properties within each component. Examples of package formats include packages for transferring employee records from one database to another, packages for retrieving sales data and translating the data into a different currency, and other general data processing functions.

Instance Data 254 is created from Template Data 252. The instance data has values for configurable properties specified in the template from which the instance was created. Instance data can be entered by a user through Interface 144 provided by Interface Engine 210 or retrieved from a file or some other source.

Parameter Files 258 are generated from Instance Data 254 and include changes contained in an instance with respect to a particular template. Package Data 256 is created from Parameter Files 258 and Template Data 252 and specifies information for one or more packages created by Application 142.

FIG. 3B is a logical block diagram of an embodiment of a package. Package 152 includes Source Component 310, Data Transformation Component 320 and Destination Component 330. Source Component 310 specifies information regarding the source of data to be retrieved. For example, Source Component 310 may indicate a server, table, column name or other data from which data is to be retrieved. Properties 312 within Source Component 310 may be used to indicate where the name of the source at which the source data is located or stored.

Data Transformation Component 320 indicates any transformations that are to be performed on data retrieved by Source Component 310. Properties 322 of the data transformation component may indicate what transformations are to be done to the retrieved data, if any. For example, data transformation component properties 322 may specify a format to display a date, an operation to be performed on a set of data (such as sum), or some other data processing operation.

Destination Component 330 handles storing the retrieved and optionally-transformed data at a particular destination. Destination Component 330 includes Properties 332 and Mappings 334. Properties 332 may indicate the name of the server, table, column name or some other location at which the data should be stored. Mappings 334 may indicate a mapping of a source column to a destination column, or some other mapping to relate the source and destination of data.

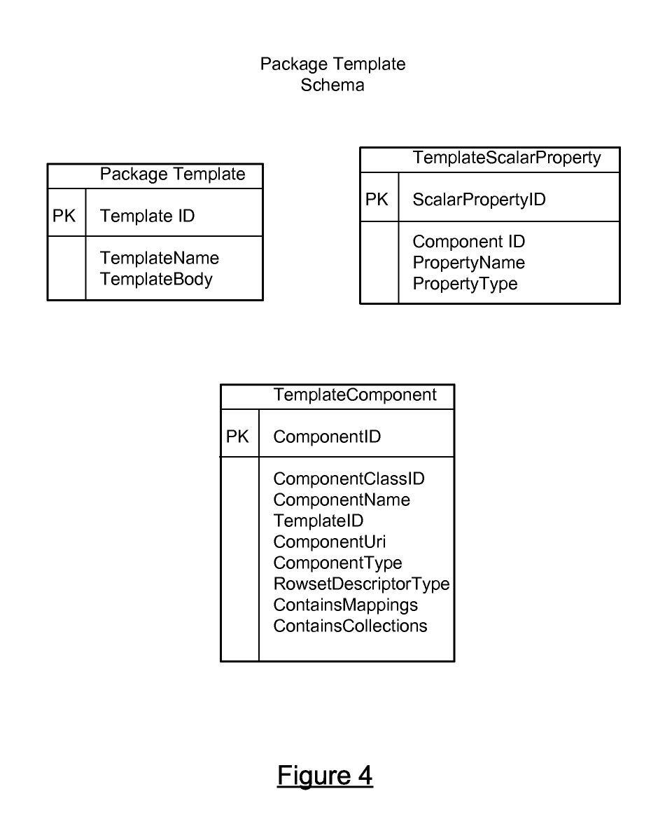

FIGS. 4-6 illustrate examples of schema which may be used to implement package templates, template instances and packages. FIG. 4 is an example of package template schema. The example package template schema includes a package template table, template scalar property table, and template component table. A scalar property may be any of properties 312, 322 and 332 as discussed above with respect to FIG. 3B. A package template table has columns of template I.D., template name and template body. The template I.D. is an identifier for the template, the template name is a name of the template, and the template body is an .xml-type data with the .xml body of an SSIS package that acts as a template.

The template scalar property table includes columns of scalar property I.D., component I.D., property name and property type. The scalar property I.D. is a unique identifier for a property of a package, the component I.D. is an identifier for a particular component, and property name may be a name of a particular property. In some embodiments, a component identifier may be made up of a package name, executable name, component name, and optionally other information. The property type can assume a value of unknown, integer, stream, date, time or bullion.

The template component table of the package template schema may contain columns of component I.D., component class I.D., component name, template I.D., component URI, component type, row set descriptor type, Contains Mappings and Contains Collections. A component URI is a path to locate the component within the template body. A component type is the type of component and can have values of package, task host, data flow task, sequence for loop, for each loop, DTS vent handler, component, variable, connection manager, precedence constraint or some other value. The row set descriptor-type column may have different types of data values. The “contains mapping” column may define whether the component contains custom mappings and the “contains collections” column defines whether the component contains configurable column collections.

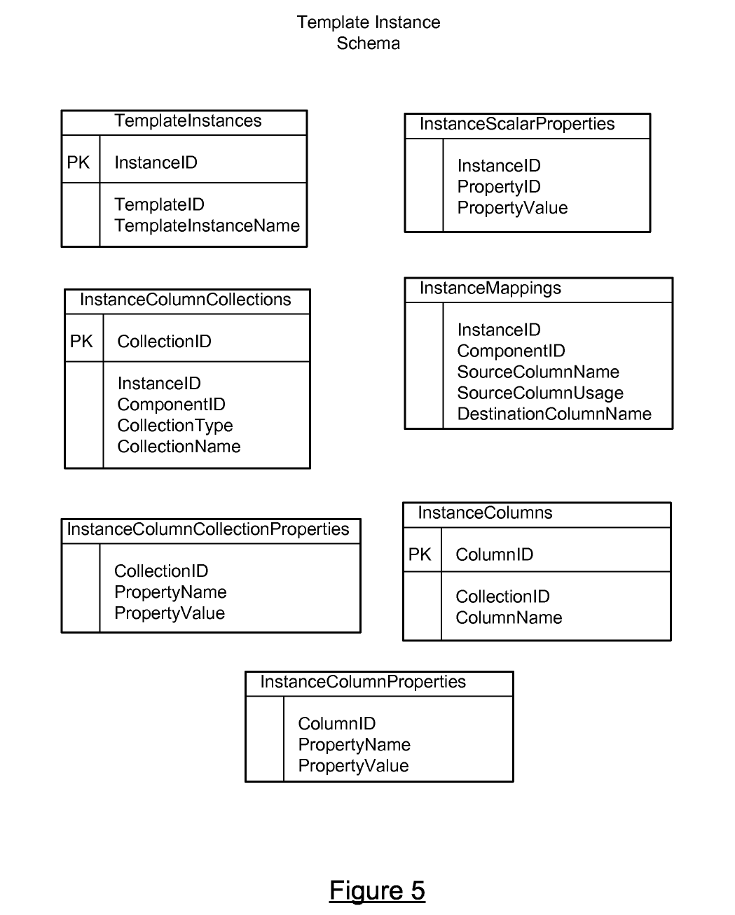

FIG. 5 illustrates a template instance schema containing seven tables. A template instances table includes an instance identifier column, template I.C., and template instance name column. The instance scalar properties table includes columns of instance I.D., property I.D. and property value. The property value column may be the value of the property which may be compatible with the corresponding property type. The instance mappings table may include columns of instance I.D., component I.D., source column name, source column usage, and destination column name. The instance I.D. may be a unique identifier for the template instance, the component I.D. may be a template configurable component identifier, a source column name may be the name of a source column, a source column usage column may indicate whether the source column is further used in the data flow, and the destination column name indicates a destination column name.

The instance column collection properties table has columns of collection I.D., property name and property value. The instance columns table has columns of column I.D., collection I.D. and collection name. The instance column properties table has columns of column I.D., property name and property value.

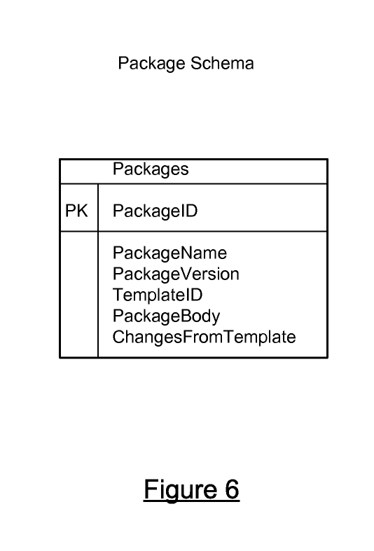

FIG. 6 illustrates a package schema package schema has one Packages table having columns of package I.D., package name, package version, template I.D., package body and Changes From Template. The package I.D. is the unique identifier for the package and the package name is the name of the package; the template I.D. is a unique identifier to the associated template; the package body column indicates and .xml body of a DTSX file for the package, and the changes from template column indicate the changes that this package contains from the associated template.

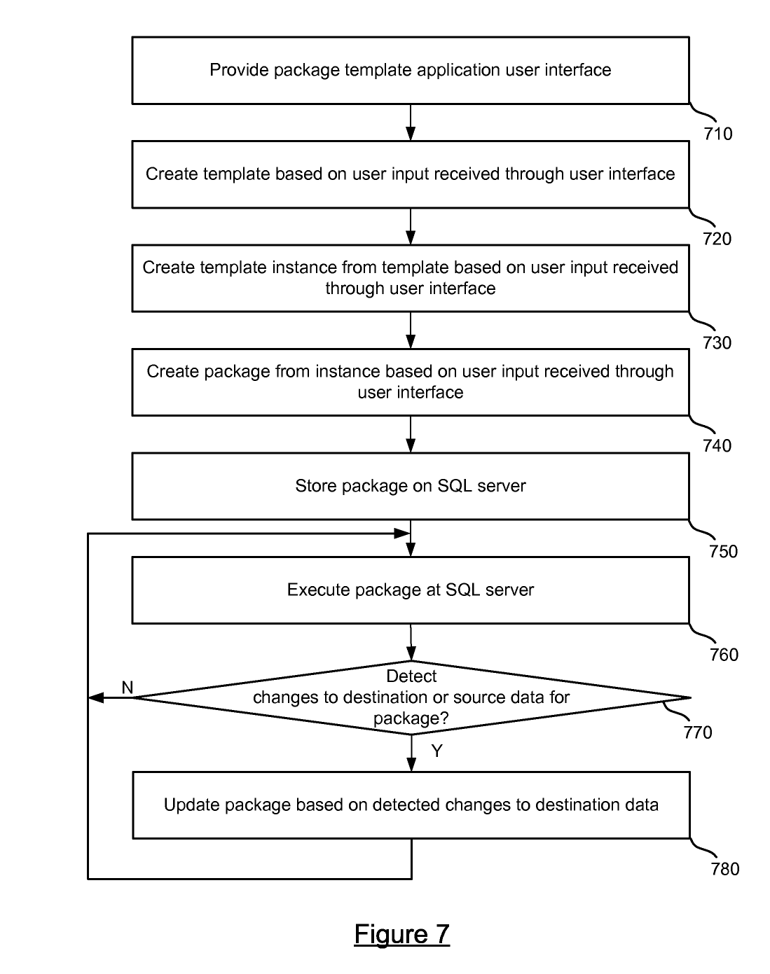

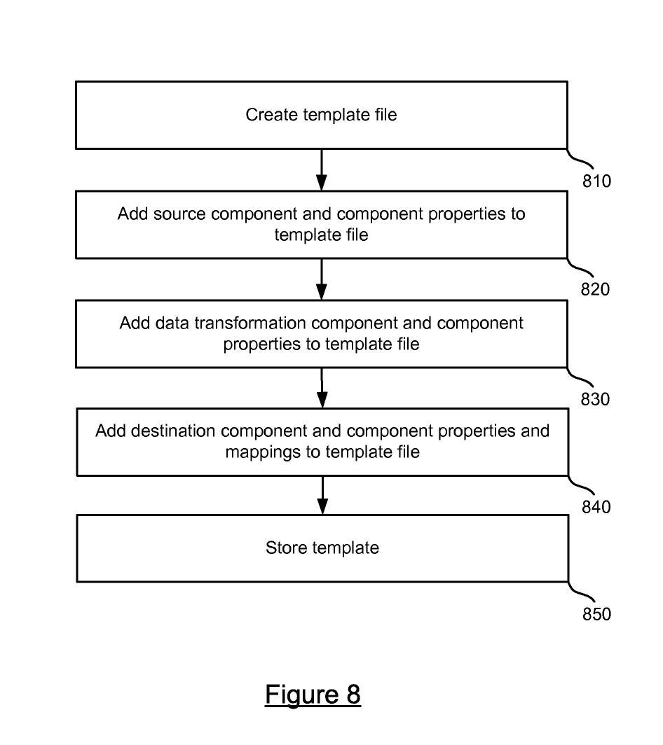

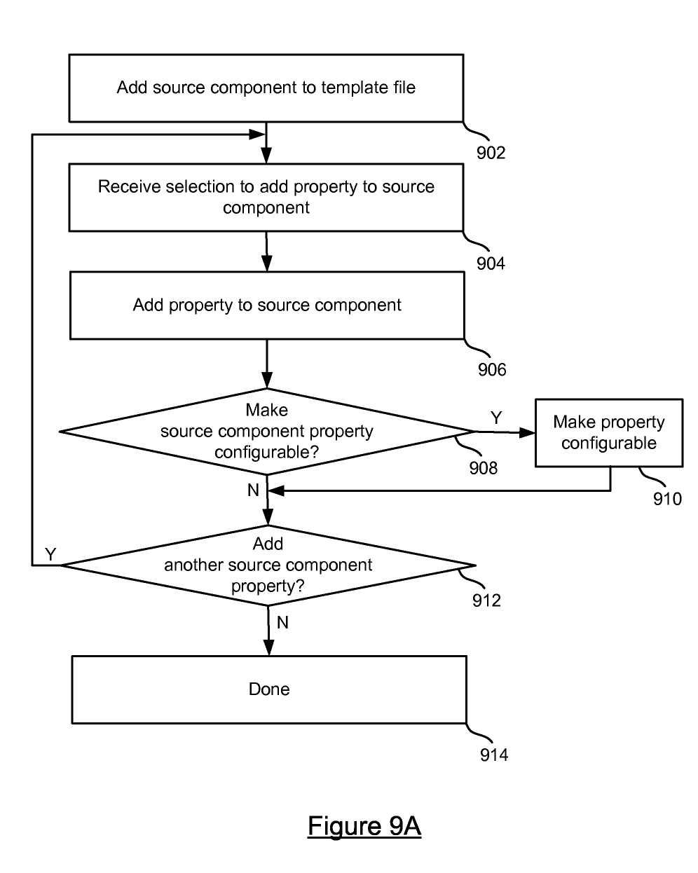

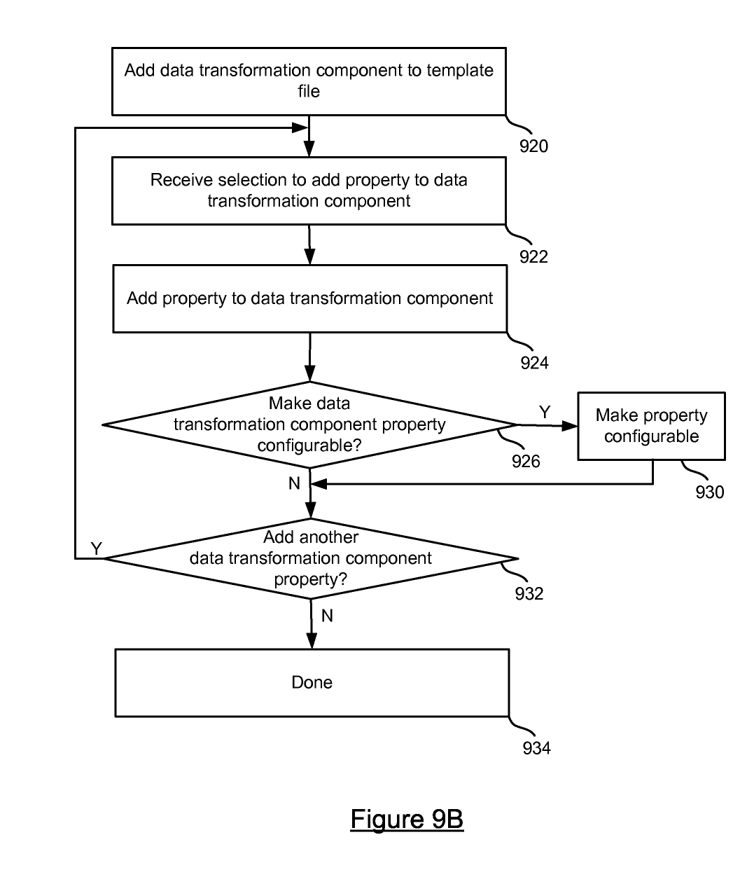

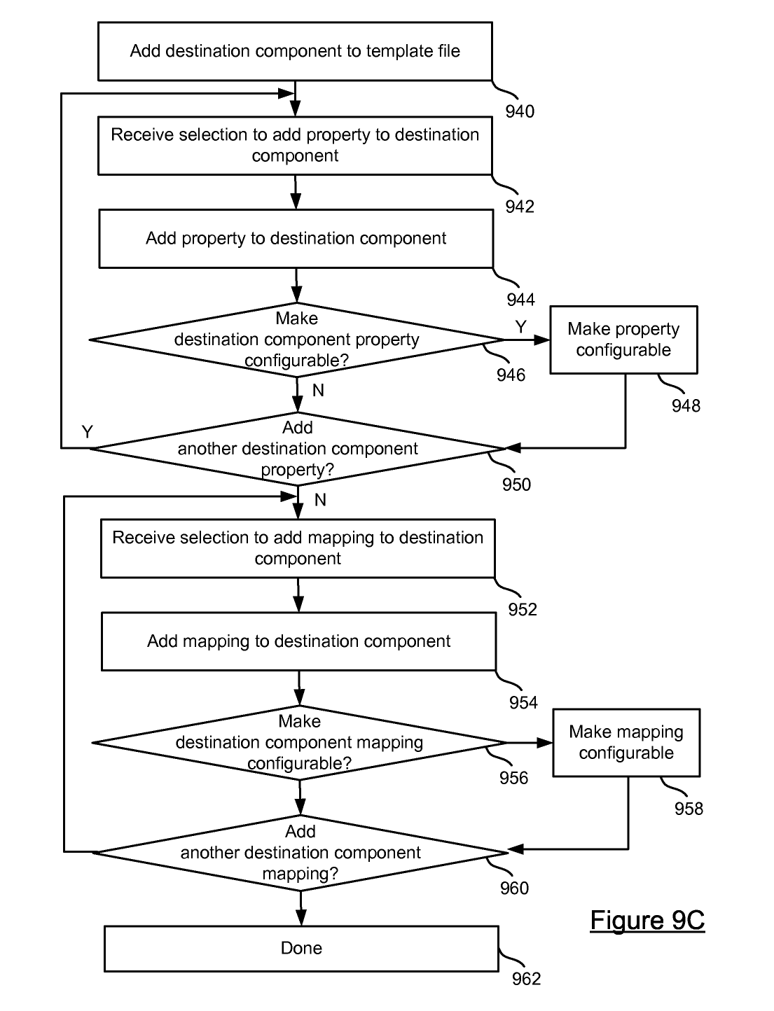

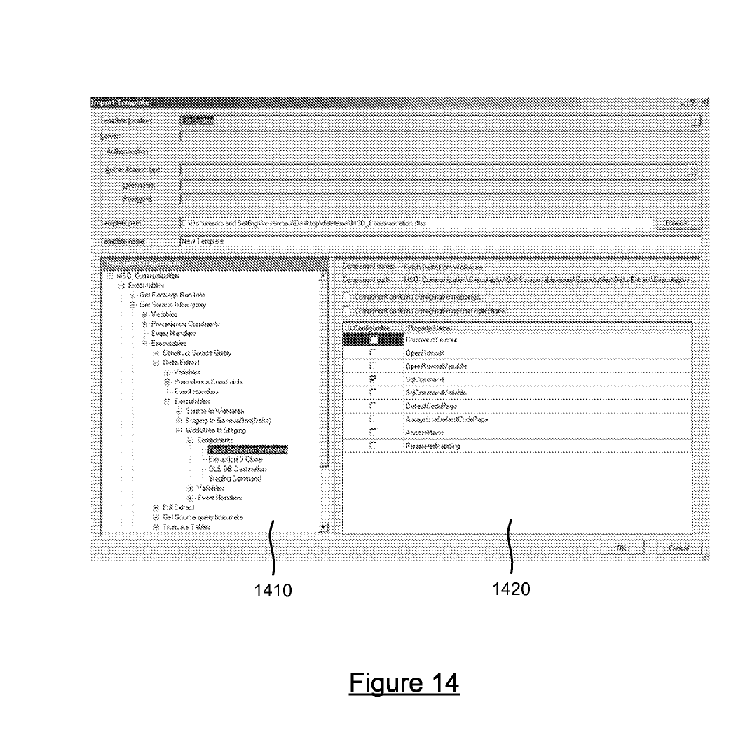

FIG. 7 is a flow chart of an embodiment of a method for creating a package. First, a package template application user interface 144 is provided at Step 710. The interface is provided when the package template application is first executed. An example of the initial interface provided is illustrated in FIG. 13 and discussed below. Next, a template is created based on user input received through user interface 144 at Step 720. The template may include components such as a source component, data transformation component and destination component. For each component, a user may indicate properties that each component may have and whether the component and those properties are configurable. Creating a template based on user input received through user interface 144 is discussed in more detail below with respect to FIGS. 8-9C. An example of an interface used to implement Step 720 is illustrated in FIG. 14 and discussed in more detail below.

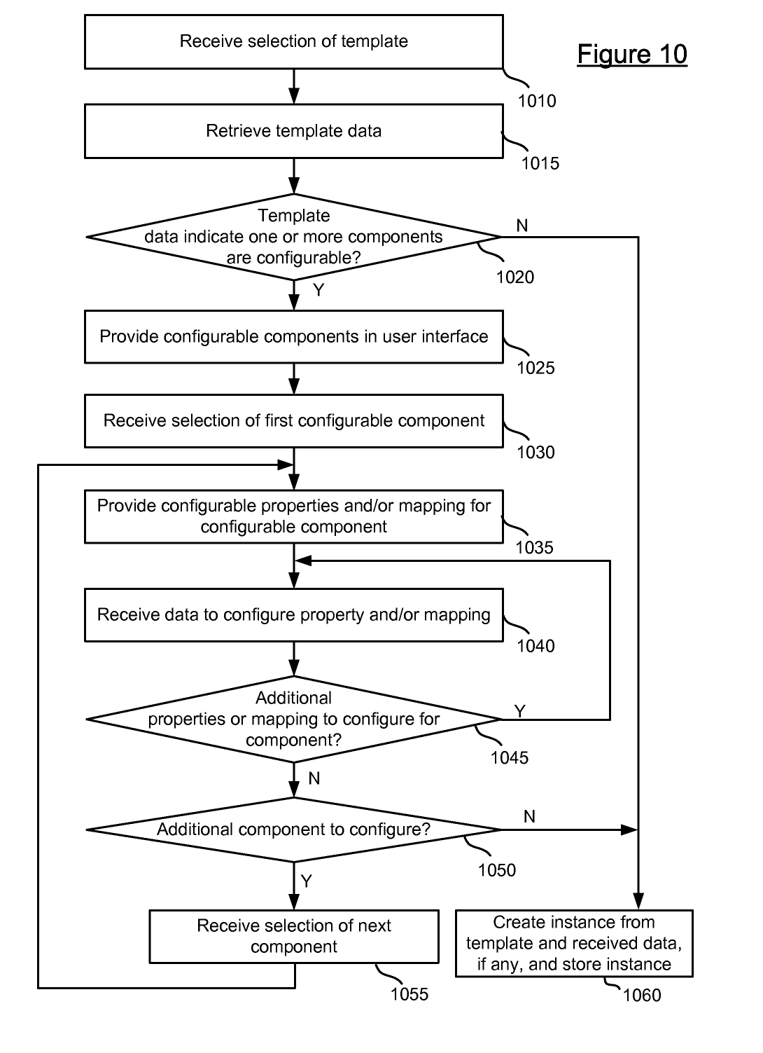

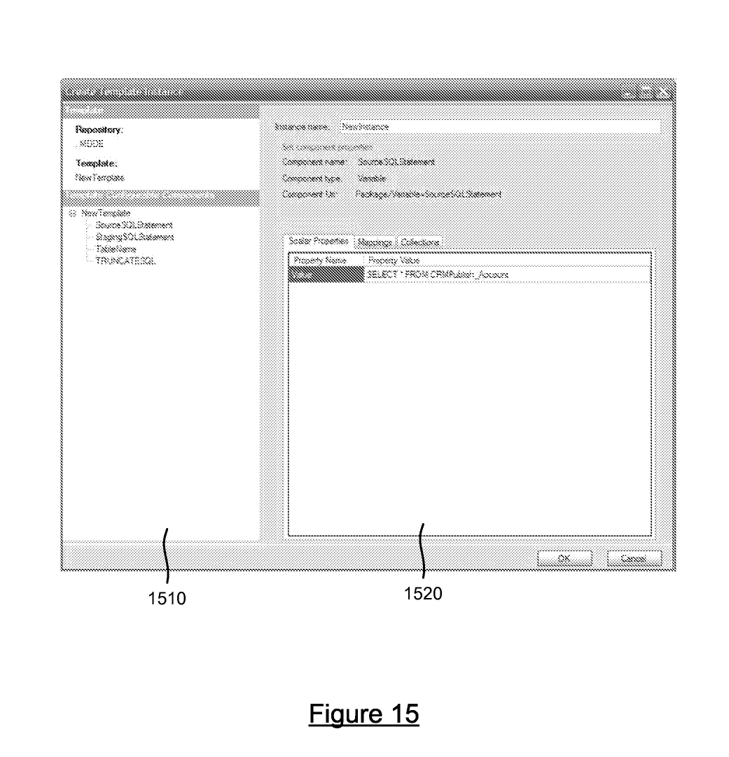

A template instance is created from the template based on user input received through User Interface 144 at Step 730. The template instance is generated based on user input received to create the instance, including values provided for configurable components and properties of the template created at Step 720. More detail for creating a template instance from a template is discussed below with respect to FIG. 10. An interface for creating a template instance is discussed below with respect to the interface of FIG. 15.

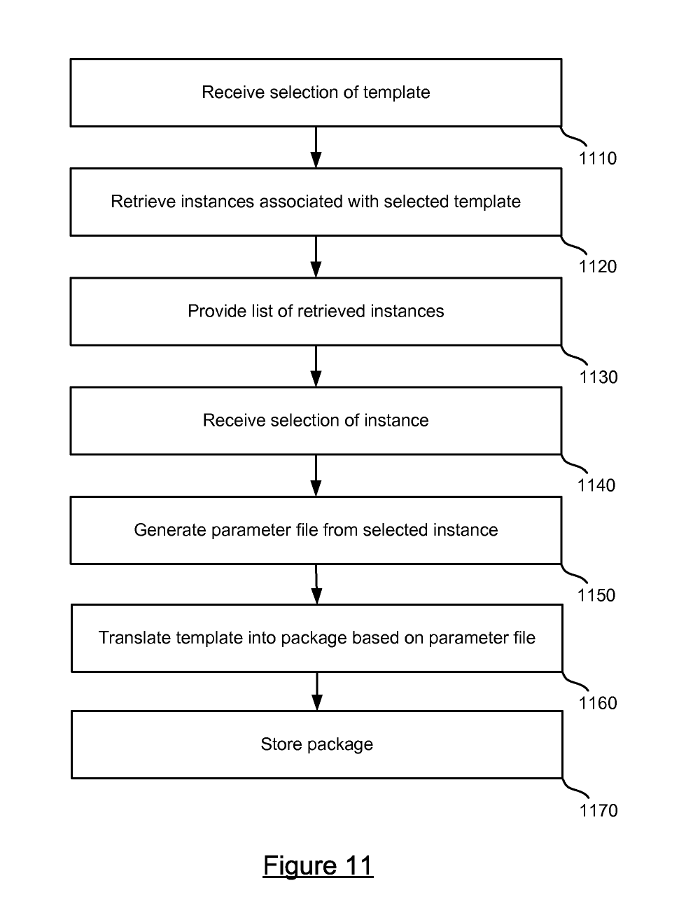

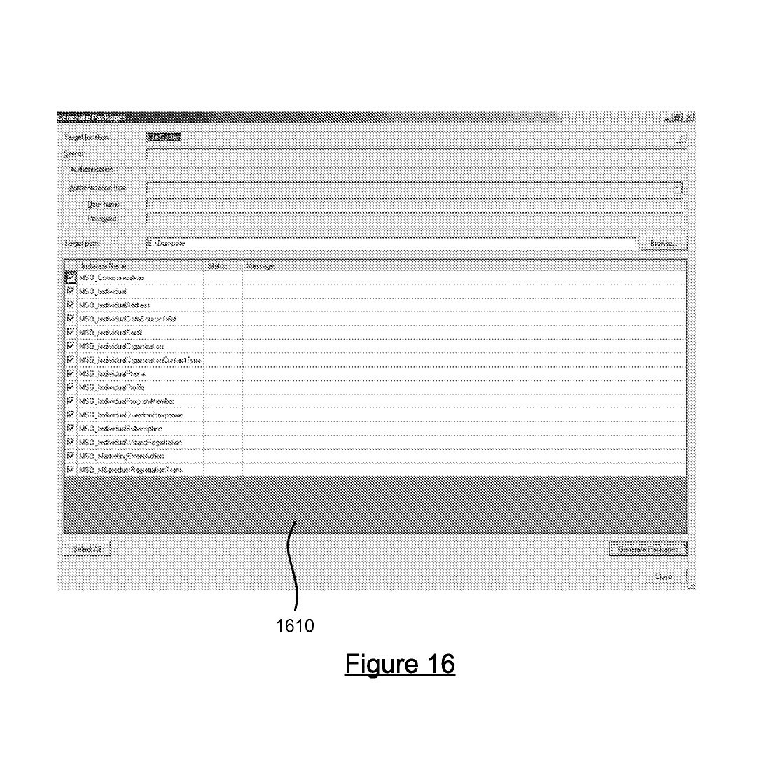

A package is created from an instance based on user input received through User Interface 144 at Step 740. Creating a package from an instance may begin with creating a parameter file from the instance. The package itself may then be created from the parameter file and the template created at Step 720. Creating a package is discussed in more detail below with respect to the method of FIG. 11. An interface for implementing the creation of a package is discussed below with respect to FIG. 16.

After the package is created, the package is stored on an SQL server at Step 750. In some embodiments, the package may be stored on Data Store 150. The stored package may then be executed at the SQL server at Step 760. Once executed, the package may perform extraction, transformation and/or loading functionality for the SQL server, for example, for a SQL server integration service application.

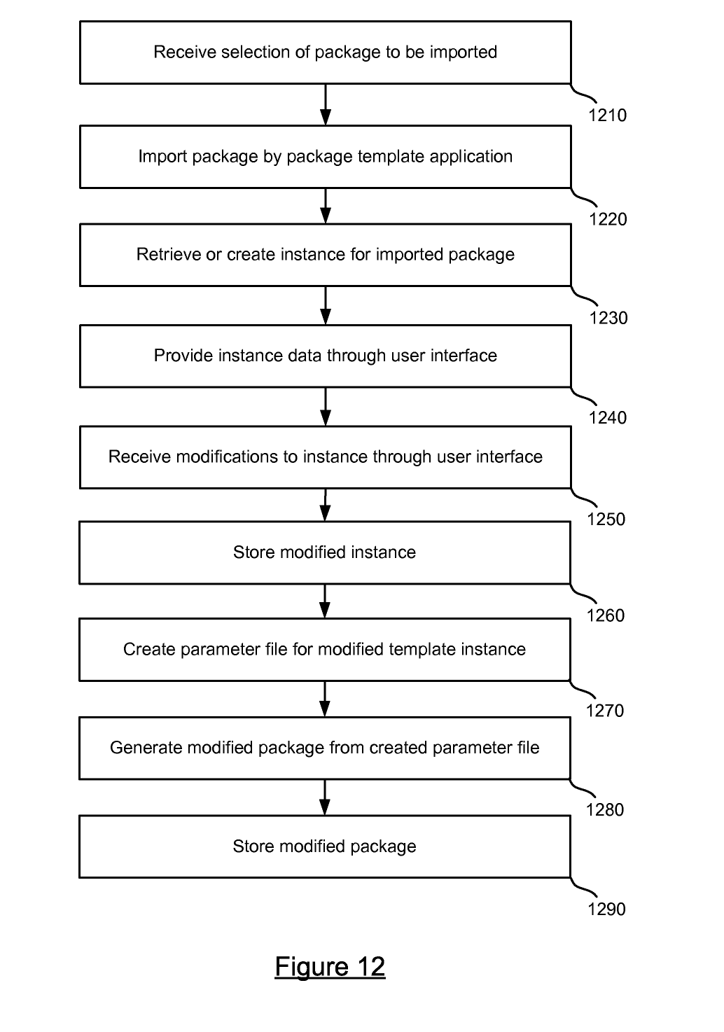

At some point, a determination is made as to whether changes to destination data or source data for the package are detected at Step 770. The changes may be detected based on a notification to a user of the system, a manual detection by the user, or in some other manner. For example, changes to destination data may include addition of a new column, removal of a column, or some other change. If no change is detected, package execution continues at Step 760. If a change is detected in source data or destination data, the package is updated based on the detected changes to the destination data at Step 780. Updating the package may include importing the package to generate an instance for the package, modifying the instance, and updating the package with the modifications. Updating a package is discussed in more detail below with respect to FIG. 12.

FIG. 8 is a flow chart of an embodiment of a method for creating a package template. In some embodiments, the method of FIG. 8 provides more detail for Step 720 of the method in FIG. 7. First, a template file is created at Step 810. The template file may be a skeleton template that includes a basic template framework. In some embodiments, once a template file is created, a user may provide a name for the template file and an identifier for the template is automatically generated and stored with the new file. Next, a source component and component properties are added to the template file at Step 820. As discussed above, the source component is the component that handles retrieving source data. Adding the source component and component properties to a template file is discussed in more detail below with respect to FIG. 9A.

Data transformation components and related component properties are added to the template file at Step 830. A data transformation component may handle transformation of data retrieved from a source before the data is stored at a destination. Adding a data transformation component and related component properties is discussed in more detail below with respect to FIG. 9B.

Destination components and related component properties and mappings are then added to the template file at Step 840. A destination component handles where retrieved data is to be stored by the package. The component properties of a destination component may indicate the details of where to store the retrieved data. The mappings of the destination component may indicate where the retrieved data was retrieved from. Adding a destination component and related component properties and mappings is discussed in more detail below with respect to FIG. 9C. After the components have been added to the template file, the template is stored at Step 850. In some embodiments, the template is stored locally at Application 142 as Template Data 152. In other embodiments, the template data may be stored elsewhere.

It should be apparent that steps 820-850 may be performed in any order, and that the order of the steps illustrated in the method of FIG. 8 is for discussion purposes only.

FIG. 9A is a flow chart of an embodiment of a method for adding a source component and component properties to a template file. In some embodiments, the method of FIG. 9A may provide more detail for Step 820 of the method of FIG. 8. First, a source component is added to a template file at Step 902. Next, Application 142 may receive a selection to add a property to the source component at Step 904. The selection to add the property may be received through User Interface 144. After receiving the selection, the property may be added to the source component at Step 906. The property may include source information such as a server name, table name, column name, type of server, or some other information. After adding the property, a determination is made as to whether the source component properties are made configurable at Step 908. In some embodiments, the component properties should be made configurable if the application receives an indication through User Interface 144 that the property should be made configurable. If the property should be made configurable, the property is made configurable by Package Template Application 142 at Step 910. The method of FIG. 9 then continues to Step 912. If the property should not be made configurable, the method continues to Step 912.

A determination is made as to whether another source component property should be added to the source component at Step 912. In some embodiments, additional component properties may be added to the source component if data is to be retrieved from more than one source, additional data is required from the particular source, or for some other reason. If another property should be added to the source component, the method of FIG. 9A returns to Step 904. If another property is not to be added to the component, the method of FIG. 9A ends at Step 914.

FIG. 9B is a flow chart of an embodiment of a method for adding a data transformation component and component properties to a template file. In some embodiments, the method of FIG. 9B provides more detail for Step 830 of the method of FIG. 8. First, a data transformation component is added to a template file at Step 920. Next, a selection is received by Application 142 to add a property to the data transformation component at Step 922. The selection may be received through Interface 144 provided by Package Template Application 142. The property is then added to the data transformation component at Step 924. The data transformation component property may indicate how the retrieved data should be transformed. For example, the property may specify a format in which the retrieved data should be expressed, such as a particular date format, metrics format, time format, a number of decimal places to use, or some other information, or specify an operation to perform on one or more fields of data, such as a sum or averaging operation.

A determination is then made as to whether the data transformation component property should be made configurable at Step 926. If the property should not be made configurable, the method of FIG. 9B continues to Step 932. If the property should be configurable, the property is made configurable at Step 930 and the method of FIG. 9B continues to Step 932.

A determination is then made as to whether another property should be added to the data transformation component at Step 932. Additional properties may be added to the data transformation component if there is more than one transformation or operation to perform on a particular data, two or more types of data need to be transformed, or for some other reason. If another property should be added to the data transformation component, the method of FIG. 9B returns to Step 922. If no further properties are to be added to the data transformation component, the method of FIG. 9B ends at Step 934.

FIG. 9C is a flow chart of an embodiment of a method for adding a destination component and related component properties and mappings to a template file. In some embodiments, the method of FIG. 9C provides more detail for Step 840 of the method of FIG. 8. First, a destination component is added to the template file at Step 940. Next, a selection is received to add a property to the destination component. The selection to add the property may be received through Interface 144 provided by Package Template Application 142. The property is then added to a destination component at Step 944. The property for the destination component may specify where the data is to be stored. For example, the property may describe a particular data store, a particular server implemented on the data store, a table name, column name(s), or some other data location.

A determination is then made as to whether the destination component property should be made configurable at Step 946. If the destination component property is not made configurable, the method at FIG. 9C continues to Step 950. If the property is to be configurable, the property is made configurable by Application 142 at Step 948, and the method of FIG. 9C continues to Step 950.

A determination is made as to whether another property should be added to the destination component at Step 950. Additional destination component properties may be added if more than one type of data is stored, a particular set of data is to be stored in more than one location, and/or for other reasons. If another destination component property is to be added to the destination component, the method at FIG. 9C returns to Step 942. If another property is not to be added to the destination component, the method at FIG. 9C continues to Step 952.

A selection is received to add a mapping to the destination component at Step 952. In some embodiments, each destination component will contain at least one mapping. A mapping indicates what source data is linked to a particular destination data. Thus, adding a mapping may involve adding a parameter for a source and a parameter for a destination. For example, the mapping may link columns names from a data source to a column of a data destination. The mapping is added to the destination component at Step 954. A determination is then made as to whether the destination component mapping should be made configurable at Step 956. If the mapping for the destination component should not be made configurable, the method of FIG. 9C continues to Step 960. If the mapping should be made configurable, the mapping is made configurable at Step 958 and the method at FIG. 9C continues to Step 960. The determination as to whether the component mapping is configurable may be made based on input received from a user through Interface 144.

A Determination is made as to whether another mapping should be configured for the component at Step 960. If no further mapping should be added to the destination component, then the method of FIG. 9C is done at Step 962. If another mapping should be added to the destination component, the method at FIG. 9C returns to Step 952.

FIG. 10 is a flow chart of an embodiment of a method for creating a template instance. In some embodiments, the method at FIG. 10 provides more detail for Step 730 of the method at FIG. 7. First, a selection of a template is received at Step 1010. The selection may be received through Interface 144 provided by Package Template Application 142. Template data 252 associated with the selection is then retrieved at Step 1015, for example, from Repository Template Data 252. A determination is then made as to whether template data 252 indicates one or more components or properties within a component are configurable at Step 1020. If no components or properties of the retrieved template are configurable, the instance is created from the template at Step 1060. When created, the identifier for the template from which the instance was created is stored as part of the instance. If the retrieved template data indicates that one or more components are configurable, the method of FIG. 10 continues to Step 1025.

Configurable components are provided through User Interface 144 at Step 1025. The configurable components may be provided in a list of components within an interface such as that of FIG. 15. Next, a selection may be received for a first configurable component at Step 1030 through Interface 144. The configurable properties and/or mappings for the configurable component are then provided to a user through the interface at Step 1035. An example of providing configurable properties and/or mappings for a configurable component is illustrated in the interface of FIG. 15.

Data is received to configure the property and/or mapping at Step 1040. The data may indicate a value for a property, such as a particular column from which to retrieve data or store data, or data for a mapping or some other input. Next, a determination is made as to whether additional properties or mappings exist to be configured for the particular component at Step 1045. If additional properties exist to be configured for the selected component, the method of FIG. 10 returns to Step 1040. If no additional properties or mappings exist to be configured for the selected component, a determination is then made as to whether there are additional components to configure at Step 1050. If there are no additional components to configure, the instance is created from the template and received data and then stored at Step 1060. The instance may be saved as instance data 254 in local repository 240 or some other location. If additional components exist to be configured, a selection is received of the next component at Step 1055 and the method of FIG. 10 returns to Step 1035.

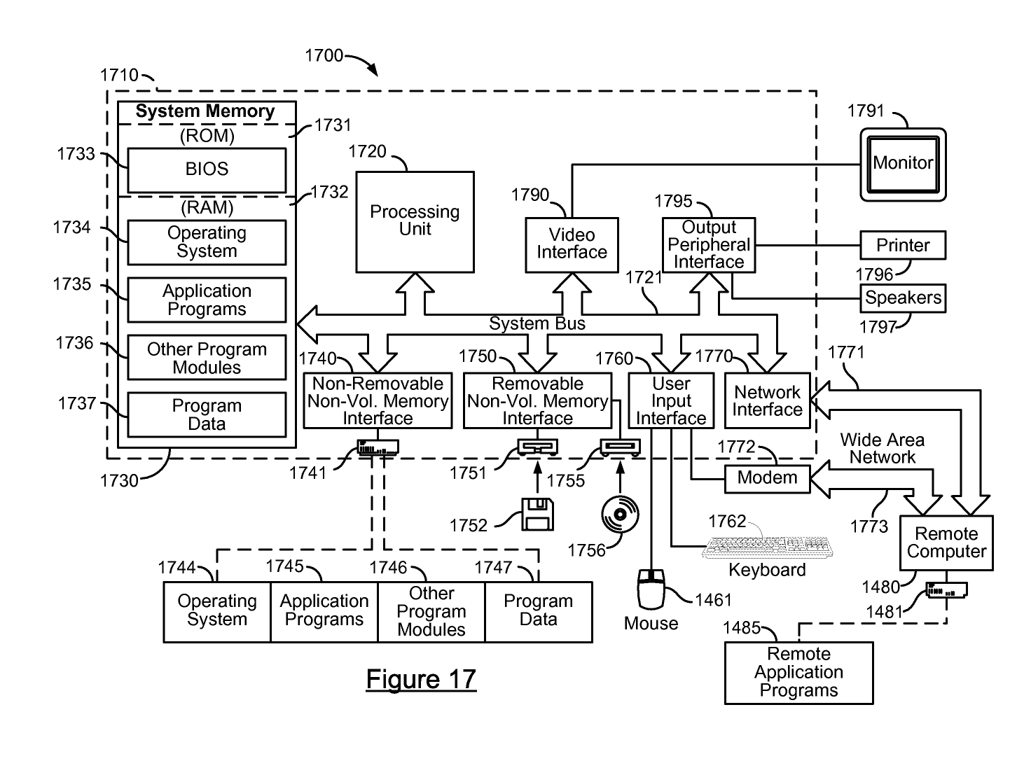

FIG. 11 is a flow chart of an embodiment of a method for creating a package. In some embodiments, the method at FIG. 11 provides more details for Step 740 of the method at FIG. 7. First, a selection is received through Interface 144 for a template at Step 1111. Instances associated with the selected template are then retrieved at Step 1120. In some embodiments, a list of instances may be retrieved based on other input received from a user. A list of retrieved instances is then provided at Step 1130. An example of an interface which provides a list of retrieved instances is shown in FIG. 17. A selection is received for a particular instance at Step 1140.

After receiving a selection of one or more instances, parameter files are generated for each selected instance at Step 1150. The parameter file may include components, properties, mappings, template I.D. from which the instance was created, instance I.D., and any other data particular to the instance which differs from the template from which the instance was created. In some embodiments, the parameter file is in .xml format. After the parameter file is generated, the template from which the instance was created is translated into a package based on the parameter file at Step 1160. Thus, changes to the template indicated in the parameter file are made to a copy of the template to generate a package from the template. The generated package is then stored as Package Data 256 at Step 1170.

As discussed above, a change may be detected in the source data, destination data or other data associated with a package at some point during execution of the package, or after the package is created. If such a change is detected, the package may be modified in order to reflect these changes. The package may be modified by importing the package, making modifications to an instance associated with the package, and creating a modified package from the modified instance. FIG. 12 is a flow chart of an embodiment of a method for updating a package. In some embodiments, the method at FIG. 12 provides more detail for Step 780.

A selection for a package to be imported is received at step 1210. The selected package is one associated with data in which a change was detected at step 770. The package may be selected through a file menu or listing provided by package template application 142. The selected package is then imported at step 1220. Importing a package may include loading the components of the package, the component properties and mappings, and property and mapping values into application 142.

An instance is retrieved or created from the imported package at step 1230. In some embodiments, the template includes an instance ID from which the package was generated. The instance ID can be used to retrieve the corresponding instance from instance data 254. In some embodiments, the instance may be created from the imported package itself. For example, application 142 may have functionality to re-generate an instance from a loaded package 152, including configurable and static properties and mappings as well as all components of the package. The configurable properties may be indicated so within the package. In some embodiments, the package may include a template ID from which it was ultimately created, and the instance may be generated based on the differences between the package and the corresponding template.

The template data created or retrieved is provided through user interface 144 at step 1240. Modifications to the instance are then received through the interface from a user at step 1250. The template instances may be modified with respect to their configurable properties, such as column names and other data. Modifying the instance may include repeating one or more of steps 1025-1055 of the method of FIG. 10. Once modified, the instance is stored as instance data 254 at step 1260. In some embodiments, the instance is stored in response to receiving input to store the instance through interface 144.

A parameter file is then created for the modified template instance at Step 1270. Creating the parameter file based on the modified template instance may be similar to creation of the parameter file discussed above with respect to Step 1150 of the method of FIG. 11. A modified package is then created from the parameter files at Step 1280. Modifying a package at step 1280 may be similar to creating a package based on a parameter file and template at step 1160 of the method of FIG. 11. The modified package is then stored as package data 256at Step 1280.

FIG. 13 is an example of an initial interface provided by Package Template Application 144. The initial interface may be used to implement Step 710 of the method at FIG. 7. The interface of FIG. 13 includes a File List Window 1310 which includes a hierarchy list of several files. These files include templates, instances, and packages. The templates listed in File List Window 1310 include “MSO Individual” and “MSO Individual New.” The template instances include “MSO Communication,” “MSO Individual,” “MSO Individual Address,” and others. The only package listed in File List Window 130 is “Individual Organization.”

FIG. 14 is an example of an interface for creating a template. In some embodiments, the interface of FIG. 14 may be used to implement Step 720 of the method at FIG. 7. The interface of FIG. 14 includes File List Window 1410 and Property Configuration Window 1420. File List Window 1410 indicates a component “Fetch Delta From Work Area” is selected. The property configuration window lists the component name, the component path, an indication as to whether the component contains configurable mappings, an indication as to whether the component contains configurable column collections, and a list of properties which may be marked as configurable. In particular, Property Configuration Window 1410 indicates that the property named “SQL Command” is marked as configurable.

FIG. 15 is an example of an interface used to create a template instance. In some embodiments, the interface at FIG. 15 is used to implement Step 730 of the method of FIG. 7. The interface of FIG. 15 includes File List Window 1510 and Property Configuration Window 1520. File List Window 1510 illustrates a template entitled “New Template” with components of “SQL statement,” “staging SQL statement,” “table name” and “truncate SQL.” The Property Configuration Window 1520 indicates the instance name, component name, component type and component unit and includes a window for entering the values for properties, mappings and collections. In particular, the value for a property name of “value” has a property value of “Select From CRM Publish Account.”

FIG. 16 is an example of an interface for generating a package. In some embodiments, the interface of FIG. 16 implements Step 740 of the method at FIG. 7. The interface of FIG. 16 includes Instance Selection Window 1610 which provides a list of instance names which may be selected for transformation into a package. Each selected instance name may be transformed into a package in response to selecting the “Generate Packages” button within the interface.

FIG. 17 is a block diagram of an embodiment of a computing environment for implementing the present technology. In some embodiments, the computing environment of FIG. 17 provides for more detail for Client 110, Network Server 130, Application Server 140, Data Store 150 and Data Bases 160-170.

Computing environment 1700 of FIG. 17 is only one example of a suitable computing environment and is not intended to suggest any limitation as to the scope of use or functionality of the technology herein. Neither should the computing environment 1700 be interpreted as having any dependency or requirement relating to any one or combination of components illustrated in the exemplary operating environment 1700.

The technology described herein is operational with numerous other general purpose or special purpose computing system environments or configurations. Examples of well known computing systems, environments, and/or configurations that may be suitable for use with the technology herein include, but are not limited to, personal computers, server computers, hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

With reference to FIG. 17, an exemplary system for implementing the technology herein includes a general purpose computing device in the form of a computer 1710. Components of computer 1710 may include, but are not limited to, a processing unit 1720, a system memory 1730, and a system bus 1721 that couples various system components including the system memory to the processing unit 1720. The system bus 1721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1710 typically includes a variety of computer readable media. Computer readable media can be any available media that can be accessed by computer 1710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1730 includes computer storage media in the form of volatile and/or nonvolatile memory such as read only memory (ROM) 1731 and random access memory (RAM) 1732. A basic input/output system 1733 (BIOS), containing the basic routines that help to transfer information between elements within computer 1710, such as during start-up, is typically stored in ROM 1731. RAM 1732 typically contains data and/or program modules that are immediately accessible to and/or presently being operated on by processing unit 1720. By way of example, and not limitation, FIG. 17 illustrates operating system 1734, application programs 1735, other program modules 1736, and program data 1737.

The computer 1710 may also include other removable/non-removable, volatile/nonvolatile computer storage media. By way of example only, FIG. 17 illustrates a hard disk drive 1740 that reads from or writes to non-removable, nonvolatile magnetic media, a magnetic disk drive 1751 that reads from or writes to a removable, nonvolatile magnetic disk 1752, and an optical disk drive 1755 that reads from or writes to a removable, nonvolatile optical disk 1756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1741 is typically connected to the system bus 1721 through a non-removable memory interface such as interface 1740, and magnetic disk drive 1751 and optical disk drive 1755 are typically connected to the system bus 1721 by a removable memory interface, such as interface 1750.

The drives and their associated computer storage media discussed above and illustrated in FIG. 17, provide storage of computer readable instructions, data structures, program modules and other data for the computer 1710. In FIG. 17, for example, hard disk drive 1741 is illustrated as storing operating system 1744, application programs 1745, other program modules 1746, and program data 1747. Note that these components can either be the same as or different from operating system 1734, application programs 1735, other program modules 1736, and program data 1737. Operating system 1744, application programs 1745, other program modules 1746, and program data 1747 are given different numbers here to illustrate that, at a minimum, they are different copies. A user may enter commands and information into the computer 170 through input devices such as a keyboard 1762 and pointing device 1761, commonly referred to as a mouse, trackball or touch pad. Other input devices (not shown) may include a microphone, joystick, game pad, satellite dish, scanner, or the like. These and other input devices are often connected to the processing unit 1720 through a user input interface 1760 that is coupled to the system bus, but may be connected by other interface and bus structures, such as a parallel port, game port or a universal serial bus (USB). A monitor 1791 or other type of display device is also connected to the system bus 1721 via an interface, such as a video interface 1790. In addition to the monitor, computers may also include other peripheral output devices such as speakers 1797 and printer 1796, which may be connected through an output peripheral interface 1790.

The computer 1710 may operate in a networked environment using logical connections to one or more remote computers, such as a remote computer 1780. The remote computer 1780 may be a personal computer, a server, a router, a network PC, a peer device or other common network node, and typically includes many or all of the elements described above relative to the computer 1710, although only a memory storage device 1781 has been illustrated in FIG. 17. The logical connections depicted in FIG. 17 include a local area network (LAN) 1771 and a wide area network (WAN) 1773, but may also include other networks. Such networking environments are commonplace in offices, enterprise-wide computer networks, intranets and the Internet.

When used in a LAN networking environment, the computer 1710 is connected to the LAN 1771 through a network interface or adapter 1770. When used in a WAN networking environment, the computer 1710 typically includes a modem 1772 or other means for establishing communications over the WAN 1773, such as the Internet. The modem 1772, which may be internal or external, may be connected to the system bus 1721 via the user input interface 1760, or other appropriate mechanism. In a networked environment, program modules depicted relative to the computer 1710, or portions thereof, may be stored in the remote memory storage device. By way of example, and not limitation, FIG. 17 illustrates remote application programs 1785 as residing on memory device 1781. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A method for generating a set of code comprising a package, comprising:
generating a template for a package configured to be used with an SQL server, the template having a source component, data transformation component and a destination component, at least one of the components including one or more properties designated as configurable by a user;
generating an instance from the template, the instance including values for the one or more configurable properties; and
creating a package from the instance, the package configured to retrieve data from one or more sources identified by the source component and store the data in one or more destinations identified by the destination component, the package including a mapping between the one or more sources and the one or more destinations.

2. The method of claim 1, wherein said steps of generating a template, generating an instance, and creating a package are performed in response to user input received through a user interface

3. The method of claim 1, wherein the source component includes at least one configurable property which identifies a data source to retrieve data from.

4. The method of claim 3, wherein the at least one configurable property identifies a server location and a data located at the server

5. The method of claim 1, wherein the data transformation component includes at least one configurable property which identifies a change to be made to data retrieved from the one or more sources.

6. The method of claim 5, wherein the at least one configurable property identifies a change to the format of the data

7. The method of claim 5, wherein the at least one configurable property identifies an operation to perform on the value of the data

8. The method of claim 1, wherein the destination component includes at least one configurable property which identifies a data destination to retrieved store data.

9. The method of claim 8, wherein the at least one configurable property identifies a server location.

10. The method of claim 1, wherein the destination component includes at least one configurable mapping which associates a data source with a data destination.

11. The method of claim 1, wherein the data is stored by a package at an SQL server.

12. The method of claim 1, further comprising:
detecting a change in data associated with a package;
importing the package;
modifying a second instance associated with the imported package; and
modifying the package in response to modifying the second instance.

13. One or more processor readable storage devices having processor readable code embodied on said processor readable storage devices, said processor readable code for programming one or more processors to perform a method comprising:
creating a first package from a template instance, the template instance containing,
a source component configured to retrieve source data,
a data transformation component configured to process the retrieved data, and
a destination component configured to store destination data at an SQL server,
the first package including at least one source component property, destination component property, and a mapping associated with the source data and destination data;
accessing an instance associated with the first package;
changing one or more component properties of the accessed instance; and
creating a modified package based on the changed instance.

14. The one or more processor readable storage devices of claim 13, the method further comprising:
identifying the first package associated with changed source data or destination data; and
importing the first package by a package application.

15. The one or more processor readable storage devices of claim 13, the method further comprising:
changing one or more properties of the destination component of the template instance in response to the change.

16. The one or more processor readable storage devices of claim 13, the method further comprising:
changing one or more properties of the source component of the template instance in response to the change.

17. The one or more processor readable storage devices of claim 13, the method further comprising:
importing the first package;
creating a second instance from the imported package;
providing information for the second instance to a user through an interface;
receiving input associated with modifications to the second instance through the interface, said step of changing performed in response to said step of receiving input associated with modifications;
storing a modified instance; and
creating a modified package from the modified instance,
said step of creating a modified package including,
creating a parameter file from the modified instance; and
creating a modified package from the parameter file and a template associated with the first package.

18. A method for generating a package for processing data, comprising:
generating a template for a package configured to be used with an SQL server, the template having a source component, data transformation component and a destination component, the source component including one or more configurable source properties, the destination component containing one or more configurable destination properties and one or more mapping properties;
generating an template instance from the template, the instance including values for the one or more configurable source properties which indicate a data source, values for one or more configurable destination properties which indicate a data destination, and values for one or more configurable mapping properties which indicate how the source data is mapped to the destination data;
creating a parameter file from the instance, the parameter file indicating changes to be made to a template based on the template instance; and
creating a package from the template and the parameter file, the package configured to retrieve data from one or more sources identified by the source component properties, transform the retrieved data, and store the transformed data in one or more destinations within an SQL server as identified by the destination component properties.

19. The method of claim 18, further comprising:
importing the package;
creating a second instance from the imported package;
providing information for the second instance to a user through an interface;
receiving input associated with modifications to the second instance through the interface, said step of changing performed in response to said step of receiving input associated with modifications;
storing a modified instance;
creating a parameter file from the modified instance; and
creating a modified package from the parameter file and a template associated with the modified instance.

20. The method of claim 18, further comprising:
executing the package to retrieve data from a data source and store the data at a data destination.
